(19) United States
(12) Patent Application Publication
(10) Pub. No.: US 2024/0130358 A1
(43) Pub. Date: Apr. 25, 2024

(54) ORGAN PERFUSION AND PRESERVATION SYSTEM AND METHOD

(71) Applicants: SORIN GROUP ITALIA S.R.L., Milano (IT); SORBONNE UNIVERSITE, Paris 6 (FR); INSTITUT NATIONAL DE LA SANTE ET DE LA RECHERCHE MEDICALE, Paris 13 (FR); ASSISTNCE PUBLIQUE- HOPTAUX DE PARIS, Paris (FR)

(72) Inventors: John F. Migliazza, Belmont Shore, CA (US); Sandra Spiritelli, Boulogne (FR); Olivier Scatton, Fontenay-Aux-Roses (FR); Eric Savier, Paris (FR); Claire Goumard, Paris (FR)

(73) Assignees: SORIN GROUP ITALIA S.R.L., Milano (IT); SORBONNE UNIVERSITE, Paris 6 (FR); INSTITUT NATIONAL DE LA SANTE ET DE LA RECHERCHE MEDICALE, Paris 13 (FR); ASSISTANCE PUBLIQUE- HOPITAUX DE PARIS, Paris (FR)

(21) Appl. No.: 18/403,061

(22) Filed: Jan. 3, 2024

Related U.S. Application Data
(63) Continuation of application No. PCT/IB2022/056504, filed on Jul. 14, 2022.
(60) Provisional application No. 63/222,036, filed on Jul. 15, 2021.

(51) Int. Cl. A01N 1/02

(52) U.S. Cl. CPC A01N 1/0247; A01N 1/021; A01N 1/0284

(57) ABSTRACT

An organ perfusion and preservation system for use in preserving an organ from a donor, may include a fluid reservoir, a heat exchanger in fluid communication with the fluid reservoir and configured to selectively raise and lower a temperature of a perfusion fluid, an oxygenator configured to oxygenate the perfusion fluid, an inflow pump in fluid communication with the fluid reservoir and the oxygenator, a fluid inflow line configured to transport perfusion fluid from the oxygenator to the organ, a fluid outflow line configured to transport perfusion fluid away from the organ and back to the reservoir, an outflow pump in fluid communication with the fluid outflow line and the fluid reservoir, and a controller operatively connected to the inflow pump, the outflow pump, and the heat exchanger, wherein the controller is configured to select parameters to reversibly heat and reversibly cool the organ.

### CROSS REFERENCE TO RELATED APPLICATIONS

This application is a continuation of International Application No. PCT/IB2022/056504, filed Jul. 14, 2022, which claims the benefit of U.S. Patent Application Ser. No. 63/222,036 filed on Jul. 15, 2021, the disclosures of which are incorporated herein by reference.

### TECHNICAL FIELD

The disclosure is directed to systems and methods for preserving and perfusing donated organs, selectively cooling donated organs to a hypothermic state for preservation, and/or selectively re-warming donated organs that have been placed into a hypothermic state for preservation.

### BACKGROUND

A finite supply of donor organs has led some transplant centers to accept marginal donated organs with increasing frequency. These marginal donated organs may be at higher risk of primary non-function, early dysfunction, and/or other recipient complications. Machine perfusion of donated organs may permit an expansion of the donor pool by limiting ischemia and/or reperfusion injury associated with preservation of the donated organ. Some donated organs not previously considered for transplantation may be rescued using machine perfusion through prolonged preservation and pre-implantation treatment(s) and/or testing of donated organ function. Of the known medical devices, systems, and methods, each has certain advantages and disadvantages. There is an ongoing need to provide alternative medical devices, systems, and methods.

### SUMMARY

In a first example, an organ perfusion and preservation system for use in preserving an organ from a donor may comprise a fluid reservoir having a perfusion fluid disposed therein; a heat exchanger in fluid communication with the fluid reservoir, the heat exchanger being configured to selectively raise and lower a temperature of the perfusion fluid; an oxygenator configured to oxygenate the perfusion fluid; an inflow pump in fluid communication with the fluid reservoir and the oxygenator; a fluid inflow line configured to transport perfusion fluid from the oxygenator to the organ; a fluid outflow line configured to transport perfusion fluid away from the organ and back to the reservoir; an outflow pump in fluid communication with the fluid outflow line and the fluid reservoir; and a controller operatively connected to the inflow pump, the outflow pump, and the heat exchanger. The controller may be configured to select parameters to reversibly heat and reversibly cool the organ.

In addition or alternatively to any example disclosed herein, the heat exchanger may be integrated into the oxygenator.

In addition or alternatively to any example disclosed herein, the controller may be configured to independently control inflow pump speed and outflow pump speed to maintain an inflow rate of perfusion fluid flowing into the organ and an outflow rate of perfusion fluid flowing out of the organ that are equal.

In addition or alternatively to any example disclosed herein, the controller may be configured to control flow of perfusion fluid to the organ based on the temperature of the perfusion fluid.

In addition or alternatively to any example disclosed herein, the controller may be configured to reduce the inflow rate of perfusion fluid when the temperature of the perfusion fluid is below 4 degrees C.

In addition or alternatively to any example disclosed herein, the controller may be configured to increase the inflow rate of perfusion fluid when the temperature of the perfusion fluid is above 37 degrees C.

In addition or alternatively to any example disclosed herein, the controller may be configured to cyclically warm and cool the organ over time.

In addition or alternatively to any example disclosed herein, the perfusion fluid includes blood from the donor.

In addition or alternatively to any example disclosed herein, the system may further include an organ holding basin having an organ bathing fluid disposed therein. The organ holding basin may be configured to receive the organ after receiving the organ from the donor.

In addition or alternatively to any example disclosed herein, the organ bathing fluid includes a preservation solution.

In addition or alternatively to any example disclosed herein, the organ bathing fluid includes blood from the donor.

In addition or alternatively to any example disclosed herein, the organ holding basin includes an inner basin and an outer shell, wherein the outer shell in configured to receive a cooling means therein.

In addition or alternatively to any example disclosed herein, the fluid reservoir includes a plurality of chambers.

In addition or alternatively to any example disclosed herein, the fluid reservoir includes a valve configured to selectively direct perfusion fluid returning to the fluid reservoir into a first chamber of the fluid reservoir or a second chamber of the fluid reservoir.

In addition or alternatively to any example disclosed herein, the first chamber includes the perfusion fluid disposed therein and the second chamber is initially empty.

In addition or alternatively to any example disclosed herein, upon initial activation of the system, perfusion fluid from the first chamber is fed into the organ through the fluid inflow line, and perfusion fluid is transported away from the organ through the fluid outflow line and into the second chamber via the valve.

In addition or alternatively to any example disclosed herein, actuation of the valve at some time after initial activation directs perfusion fluid returning from the organ into the first chamber.

In addition or alternatively to any example disclosed herein, after actuating the valve to direct perfusion fluid into the first chamber, perfusion fluid is thereafter recirculated between the first chamber and the organ.

In addition or alternatively to any example disclosed herein, the first chamber is configured to hold a maximum of 1300 mL and the second chamber is configured to hold a maximum of 2700 mL.

In addition or alternatively to any example disclosed herein, the controller is configured to select between a plurality of operational modes.

In addition or alternatively to any example disclosed herein, the plurality of operational modes includes a de-fatting mode, a re-warming mode, a maintain viability mode, and/or a therapy mode.

In addition or alternatively to any example disclosed herein, the fluid reservoir holds a volume of perfusion fluid between 1000 mL and 5000 mL.

In addition or alternatively to any example disclosed herein, the oxygenator is connectable to an air supply.

In addition or alternatively to any example disclosed herein, the organ holding basin is insulated.

In addition or alternatively to any example disclosed herein, the organ holding basin is in fluid communication with the heat exchanger to selectively raise and lower a temperature of the organ bathing fluid.

In addition or alternatively to any example disclosed herein, a perfusion fluid filter is disposed between the reservoir and the oxygenator.

In addition or alternatively, and in a second example, a method of selectively re-warming a donated organ for transplantation may comprise: disposing the donated organ in an organ holding basin containing a preservation solution disposed therein, wherein at least some preservation solution is disposed within the donated organ; connecting a fluid inflow line and a fluid outflow line of an organ perfusion and preservation system to the donated organ, wherein the organ perfusion and preservation system comprises:
a fluid reservoir having a perfusion fluid disposed therein;
a heat exchanger in fluid communication with the fluid reservoir, the heat exchanger being configured to selectively raise and lower a temperature of the perfusion fluid;
an oxygenator configured to oxygenate the perfusion fluid;
an inflow pump in fluid communication with the fluid reservoir and the oxygenator;
wherein the fluid inflow line is configured to transport perfusion fluid from the oxygenator to the donated organ and the fluid outflow line is configured to transport perfusion fluid away from the donated organ and back to the reservoir;
an outflow pump in fluid communication with the fluid outflow line and the fluid reservoir; and
a controller operatively connected to the inflow pump, the outflow pump, and the heat exchanger;
wherein the controller is configured to select parameters to reversibly heat and reversibly cool the donated organ;
wherein the fluid reservoir includes a plurality of chambers and a valve configured to selectively direct perfusion fluid returning to the fluid reservoir into a first chamber of the fluid reservoir or a second chamber of the fluid reservoir;
   activating the inflow pump to transport perfusion fluid from the first chamber of the fluid reservoir to the donated organ; activating the outflow pump to transport perfusion fluid mixed with preservation solution away from the donated organ and to the second chamber; actuating the valve to direct perfusion fluid being transported away from the donated organ into the first chamber after the perfusion fluid contains less than 20% preservation solution mixed therein; and thereafter, recirculating the perfusion fluid between the first chamber and the donated organ.

In addition or alternatively to any example disclosed herein, the method may further comprise warming the perfusion fluid with the heat exchanger to raise a temperature of the donated organ to a first temperature.

In addition or alternatively to any example disclosed herein, the method may further comprise, after warming the perfusion fluid, cooling the perfusion fluid with the heat exchanger to lower the temperature of the donated organ to a second temperature.

In addition or alternatively to any example disclosed herein, the method may further comprise, after cooling the perfusion fluid, re-warming the perfusion fluid with the heat exchanger to raise the temperature of the donated organ to a third temperature.

In addition or alternatively to any example disclosed herein, the third temperature is equal to the first temperature.

In addition or alternatively to any example disclosed herein, the third temperature is greater than the first temperature.

In addition or alternatively to any example disclosed herein, the third temperature is less than the first temperature.

In addition or alternatively to any example disclosed herein, the method may further comprise cyclically raising and lowering the temperature of the donated organ within a range of 2 degrees C. to 40 degrees C.

In addition or alternatively to any example disclosed herein, the method may further comprise warming the perfusion fluid with the heat exchanger to raise a temperature of the donated organ to 37 degrees C.; applying a therapy to the donated organ; and cooling the perfusion fluid with the heat exchanger to lower the temperature of the donated organ to 4 degrees C.

In addition or alternatively to any example disclosed herein, applying the therapy includes introducing a medicament into the perfusion fluid.

In addition or alternatively, and in a third example, a method of preserving a donated organ for transplantation may comprise: disposing the donated organ in an organ holding basin containing an organ bathing fluid disposed therein; connecting a fluid inflow line and a fluid outflow line of an organ perfusion and preservation system to the donated organ, wherein the organ perfusion and preservation system comprises:
a fluid reservoir having a perfusion fluid disposed therein;
a heat exchanger in fluid communication with the fluid reservoir, the heat exchanger being configured to selectively raise and lower a temperature of the perfusion fluid;
an oxygenator configured to oxygenate the perfusion fluid;
an inflow pump in fluid communication with the fluid reservoir and the oxygenator;
wherein the fluid inflow line is configured to transport perfusion fluid from the oxygenator to the donated organ and the fluid outflow line is configured to transport perfusion fluid away from the donated organ and back to the reservoir;
an outflow pump in fluid communication with the fluid outflow line and the fluid reservoir; and
a controller operatively connected to the inflow pump, the outflow pump, and the heat exchanger;
wherein the controller is configured to select parameters to reversibly heat and reversibly cool the donated organ;
   activating the inflow pump to transport perfusion fluid from the fluid reservoir to the donated organ; activating the outflow pump to transport perfusion fluid away from the donated organ and back to the fluid reservoir; cooling the perfusion fluid with the heat exchanger to lower a temperature of the donated organ to a first temperature; and recirculating the perfusion fluid between the fluid reservoir and the donated organ.

In addition or alternatively to any example disclosed herein, the method may further comprise, after cooling the perfusion fluid, warming the perfusion fluid with the heat exchanger to raise the temperature of the donated organ to a second temperature.

In addition or alternatively to any example disclosed herein, the method may further comprise, after warming the perfusion fluid, re-cooling the perfusion fluid with the heat exchanger to lower the temperature of the donated organ to a third temperature.

In addition or alternatively to any example disclosed herein, the third temperature is equal to the first temperature.

In addition or alternatively to any example disclosed herein, the third temperature is greater than the first temperature.

In addition or alternatively to any example disclosed herein, the third temperature is less than the first temperature.

In addition or alternatively to any example disclosed herein, the method may further comprise cyclically raising and lowering the temperature of the donated organ within a range of 2 degrees C. to 40 degrees C.

In addition or alternatively to any example disclosed herein, the method may further comprise warming the perfusion fluid with the heat exchanger to raise the temperature of the donated organ to 37 degrees C.; applying a therapy to the donated organ; and cooling the perfusion fluid with the heat exchanger to lower the temperature of the donated organ to 4 degrees C.

In addition or alternatively to any example disclosed herein, applying the therapy includes introducing a medicament into the perfusion fluid.

The above summary of some embodiments, aspects, and/or examples is not intended to describe each embodiment or every implementation of the present disclosure. The figures and the detailed description which follows more particularly exemplify these embodiments.

### BRIEF DESCRIPTION OF THE DRAWINGS

Embodiments of the present disclosure may be more completely understood in consideration of the following detailed description in connection with the accompanying drawings, in which:

FIG. 1 is a block diagram representing selected aspects of a system for preserving and perfusing donated organs;

FIG. 2 illustrates selected aspects of a fluid reservoir of the system of FIG. 1;

FIG. 3 illustrates selected aspects of a fluid reservoir of the system of FIG. 1;

FIG. 4 illustrates selected aspects of a pump system of the system of FIG. 1;

FIG. 5 illustrates selected aspects of an oxygenator of the system of FIG. 1;

FIG. 6 illustrates selected aspects of an organ holding basin of the system of FIG. 1;

FIG. 7 illustrates selected aspects of a controller and/or display of the system of FIG. 1;

FIG. 8 illustrates selected aspects of an example configuration of the system of FIG. 1;

FIG. 9 illustrates selected aspects of an alternative configuration of the system of FIG. 1; and

FIG. 10 illustrates aspects of a system connecting a patient to an extracorporeal organ.

While the embodiments of the present disclosure are amenable to various modifications and alternative forms, specifics thereof have been shown by way of example in the drawings and will be described in detail. It should be understood, however, that the intention is not to limit aspects of the present disclosure to the particular embodiments described. On the contrary, the intention is to cover all modifications, equivalents, and alternatives falling within the spirit and scope of the present disclosure.

### DETAILED DESCRIPTION

The following description should be read with reference to the drawings, which are not necessarily to scale, wherein like reference numerals indicate like elements throughout the several views. The detailed description and drawings are intended to illustrate but not limit the claims. Those skilled in the art will recognize that the various elements described and/or shown may be arranged in various combinations and configurations without departing from the scope of the disclosure. The detailed description and drawings illustrate example embodiments. However, in the interest of clarity and ease of understanding, while every feature and/or element may not be shown in each drawing, the feature(s) and/or element(s) may be understood to be present regardless, unless otherwise specified.

For the following defined terms, these definitions shall be applied, unless a different definition is given in the claims or elsewhere in this specification.

All numeric values are herein assumed to be modified by the term “about,” whether or not explicitly indicated. The term “about”, in the context of numeric values, generally refers to a range of numbers that one of skill in the art would consider equivalent to the recited value (e.g., having the same function or result). In many instances, the term “about” may include numbers that are rounded to the nearest significant figure. Other uses of the term “about” (e.g., in a context other than numeric values) may be assumed to have their ordinary and customary definition(s), as understood from and consistent with the context of the specification, unless otherwise specified.

The recitation of numerical ranges by endpoints includes all numbers within that range, including the endpoints (e.g., 1 to 5 includes 1, 1.5, 2, 2.75, 3, 3.80, 4, and 5).

Although some suitable dimensions, ranges, and/or values pertaining to various components, features and/or specifications are disclosed, one of skill in the art, incited by the present disclosure, would understand desired dimensions, ranges, and/or values may deviate from those expressly disclosed.

As used in this specification and the appended claims, the singular forms “a”, “an”, and “the” include plural referents unless the content clearly dictates otherwise. As used in this specification and the appended claims, the term “or” is generally employed in its sense including “and/or” unless the content clearly dictates otherwise. It is to be noted that in order to facilitate understanding, certain features of the disclosure may be described in the singular, even though those features may be plural or recurring within the disclosed embodiment(s). Each instance of the features may include and/or be encompassed by the singular disclosure(s), unless expressly stated to the contrary. For simplicity and clarity purposes, not all elements of the embodiments of the present disclosure are necessarily shown in each figure or discussed in detail below. However, it will be understood that the following discussion may apply equally to any and/or all of the components for which there are more than one, unless explicitly stated to the contrary. Additionally, not all instances of some elements or features may be shown in each figure for clarity.

Relative terms such as “proximal”, “distal”, “advance”, “retract”, variants thereof, and the like, may be generally considered with respect to the positioning, direction, and/or operation of various elements relative to a user/operator/manipulator of the device, wherein “proximal” and “retract” indicate or refer to closer to or toward the user and “distal” and “advance” indicate or refer to farther from or away from the user. In some instances, the terms “proximal” and “distal” may be arbitrarily assigned in an effort to facilitate understanding of the disclosure, and such instances will be readily apparent to the skilled artisan. Other relative terms, such as “upstream”, “downstream”, “inflow”, and “outflow” refer to a direction of fluid flow within a lumen, such as a body lumen, a blood vessel, or within a device.

The term “extent” may be understood to mean a greatest measurement of a stated or identified dimension, unless the extent or dimension in question is preceded by or identified as a “minimum”, which may be understood to mean a smallest measurement of the stated or identified dimension. For example, “outer extent” may be understood to mean an outer dimension, “radial extent” may be understood to mean a radial dimension, “longitudinal extent” may be understood to mean a longitudinal dimension, etc. Each instance of an “extent” may be different (e.g., axial, longitudinal, lateral, radial, circumferential, etc.) and will be apparent to the skilled person from the context of the individual usage. Generally, an “extent” may be considered a greatest possible dimension measured according to the intended usage, while a “minimum extent” may be considered a smallest possible dimension measured according to the intended usage. In some instances, an “extent” may generally be measured orthogonally within a plane and/or cross-section, but may be, as will be apparent from the particular context, measured differently—such as, but not limited to, angularly, radially, circumferentially (e.g., along an arc), etc.

The terms “monolithic” and “unitary” shall generally refer to an element or elements made from or consisting of a single structure or base unit/element. A monolithic and/or unitary element shall exclude structure and/or features made by assembling or otherwise joining multiple discrete elements together.

It is noted that references in the specification to “an embodiment”, “some embodiments”, “other embodiments”, etc., indicate that the embodiment(s) described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it would be within the knowledge of one skilled in the art to effect the particular feature, structure, or characteristic in connection with other embodiments, whether or not explicitly described, unless clearly stated to the contrary. That is, the various individual elements described below, even if not explicitly shown in a particular combination, are nevertheless contemplated as being combinable or arrangeable with each other to form other additional embodiments or to complement and/or enrich the described embodiment(s), as would be understood by one of ordinary skill in the art.

For the purpose of clarity, certain identifying numerical nomenclature (e.g., first, second, third, fourth, etc.) may be used throughout the description and/or claims to name and/or differentiate between various described and/or claimed features. It is to be understood that the numerical nomenclature is not intended to be limiting and is exemplary only. In some embodiments, alterations of and deviations from previously-used numerical nomenclature may be made in the interest of brevity and clarity. That is, a feature identified as a “first” element may later be referred to as a “second” element, a “third” element, etc. or may be omitted entirely, and/or a different feature may be referred to as the “first” element. The meaning and/or designation in each instance will be apparent to the skilled practitioner.

Cold storage and/or preservation of donated organs is a common preservation technique for keeping a donated organ transplantable for several hours without severe loss of viability. In traditional cold storage techniques, an organ is received from a donor and placed into a cold storage vessel and chilled to a hypothermic state, using ice for example. However, static preservation techniques have limits that compromise the viability of the donated organ after a certain period of time (in some cases up to 24 to 48 hours) due to depletion of oxygen and nutrients within the donated organ. Additionally, ischemia-reperfusion injury can occur when blood supply to a tissue is blocked for minutes to hours and afterwards restored.

Preservation techniques involving perfusion of a donated organ may reduce injury to donated organs and extend preservation time by a significant amount before severe loss of viability occurs. However, perfusion of a donated organ in a hypothermic state may have limited benefit(s) due to reduced metabolic activity in the donated organ while in the hypothermic state. A system that can selectively control both the cooling and re-warming of a donated organ, while perfusion of the donated organ is used to supply oxygen, necessary nutrients, and/or therapy to the donated organ, may improve the length of time the donated organ may survive preservation prior to implantation into a recipient. The system may be capable of managing inflow of perfusion fluid to the donated organ and outflow of perfusion fluid from the donated organ independently. Additional features and/or benefits of the system are discussed in more detail herein.

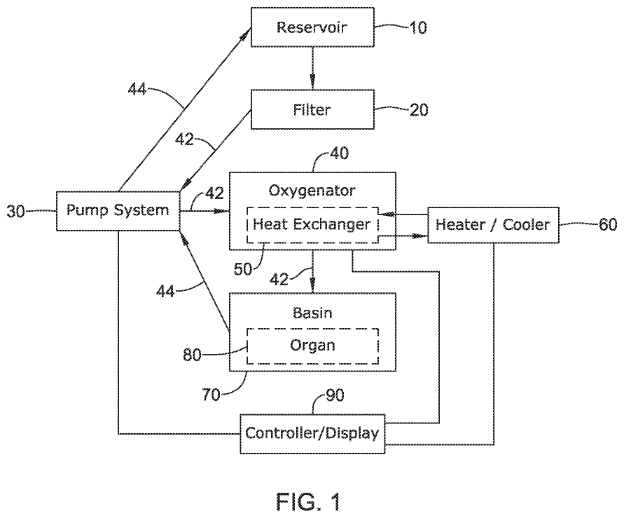

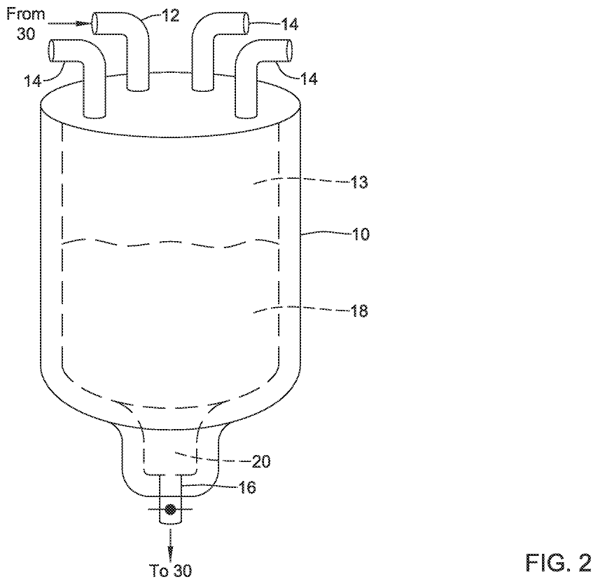

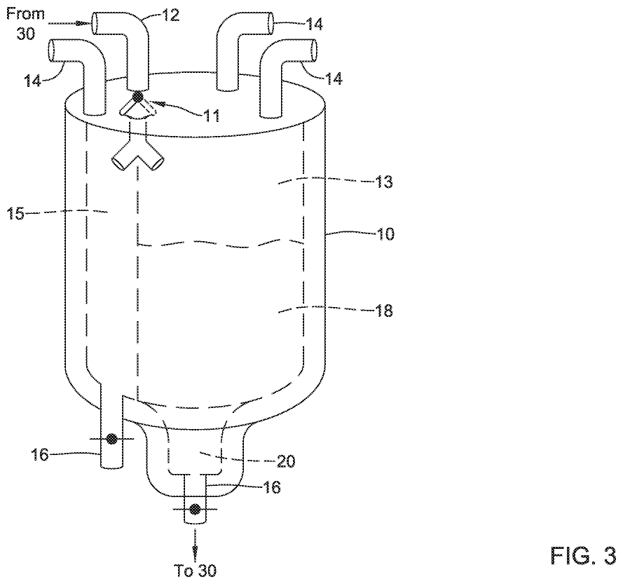

FIG. 1 illustrates a block diagram of an organ perfusion and preservation system for use in preserving an organ from a donor. The organ perfusion and preservation system may include a fluid reservoir 10 having a perfusion fluid 18 (e.g., FIGS. 2-3) disposed therein. In some embodiments, the perfusion fluid 18 may include a fluid capable of carrying oxygen and/or nutrients. In some embodiments, the perfusion fluid 18 may include donated blood (e.g., blood from a blood bank). In at least some embodiments, the perfusion fluid 18 may include blood from the donor of the donated organ. In some embodiments, the perfusion fluid 18 may include and/or may be a preservation solution, a machine perfusion solution, or blood mixed with other components to achieve desired physical and/or functional properties at various temperatures. The fluid reservoir 10 may be operatively connected to a perfusion fluid filter 20 disposed between the fluid reservoir 10 and an oxygenator 40. In some embodiments, the system may include a pump system 30, as described in more detail herein. In some embodiments, the system may include a heat exchanger 50 operatively connected to a temperature changing unit 60 (e.g., a heater/cooler). In some embodiments, the heat exchanger 50 may be operatively connected to the oxygenator 40.

The fluid reservoir 10, the perfusion fluid filter 20, the pump system 30, the oxygenator 40, and/or the heat exchanger 50 may be fluidly connected to an organ holding basin 70 and/or the donated organ 80 disposed in the organ holding basin 70 by a fluid inflow line 42 configured to transport perfusion fluid from the oxygenator 40 to the donated organ 80. In some embodiments, the fluid inflow line 42 may comprise one fluid inflow line, two fluid inflow lines, three fluid inflow lines, or more fluid inflow lines (e.g., one or more fluid inflow lines, at least one fluid inflow line, a plurality of fluid inflow lines, etc.). For example, in some embodiments, the fluid inflow line 42 may comprise and/or include a plurality of fluid inflow line segments, wherein each of the plurality of fluid inflow line segments flows in a first direction (e.g., away from the fluid reservoir 10 and/or toward the organ holding basin 70 and/or the donated organ 80). Similarly, the fluid inflow line 42 may flow in the first direction (e.g., away from the fluid reservoir 10 and/or toward the organ holding basin 70 and/or the donated organ 80).

Similarly, the fluid reservoir 10 and the pump system 30 may be fluidly connected to the organ holding basin 70 and/or the donated organ 80 disposed in the organ holding basin 70 by a fluid outflow line 44 configured to transport perfusion fluid away from the donated organ 80 and back to the fluid reservoir 10. In some embodiments, the fluid outflow line 44 may comprise one fluid outflow line, two fluid outflow lines, three fluid outflow lines, or more fluid outflow lines (e.g., one or more fluid outflow lines, at least one fluid outflow line, a plurality of fluid outflow lines, etc.). For example, in some embodiments, the fluid outflow line 44 may comprise and/or include a plurality of fluid outflow line segments, wherein each of the plurality of fluid outflow line segments flows in a second direction (e.g., away from the organ holding basin 70 and/or the donated organ 80 and/or toward the fluid reservoir 10). Similarly, the fluid outflow line 44 may flow in the second direction (e.g., away from the organ holding basin 70 and/or the donated organ 80 and/or toward the fluid reservoir 10).

In some embodiments, the system may further include one or more additional outflow lines and/or outflow line segments configured to collect and/or transport fluid(s) from the donated organ 80. For example, the one or more additional outflow lines and/or outflow line segments may connect to and/or transport fluid(s) from a bile duct when treating and/or perfusing a liver, a ureter when treating and/or perfusing a kidney, etc. to permit functional assessment of the donated organ 80.

In some embodiments, the system may include a controller 90 operatively and/or electronically connected to the pump system 30, the oxygenator 40, the heat exchanger 50, and/or the temperature changing unit 60 (e.g., the heater/cooler). In some embodiments, the controller 90 may include a display and user interface.

In some embodiments, the system may include one or more additional components as needed or desired. For example, in some embodiments, the system may include a dialysis system, a hemofiltration system, and/or a hemodiafiltration system to reduce and/or eliminate inflammatory elements (e.g., toxins, cytokines, etc.) from the perfusion fluid 18, the fluid reservoir 10, and/or other elements or components of the system. Other and/or additional system components are also contemplated.

FIG. 2 illustrates one example configuration of the fluid reservoir 10 associated with the system. In some embodiments, the fluid reservoir 10 may include a plurality of inlet ports fluidly connected to a first chamber 13 disposed within the fluid reservoir 10. In some embodiments, the plurality of inlet ports may include a first port 12 and a second port 14. In some embodiments, the second port 14 may include a plurality of second ports. In some embodiments, the plurality of inlet ports may be configured to receive drug infusions, additional perfusion fluid, or other suitable connections or uses. In at least some embodiments, each of the plurality of inlet ports may include a valve, a seal, a gasket, a diaphragm, or other covering configured to prevent contamination of the fluid reservoir 10, the first chamber 13, and/or the perfusion fluid 18 disposed within the fluid reservoir 10 and/or the first chamber 13.

In some embodiments, the fluid reservoir 10 may be formed from a metallic material, a polymeric material, a ceramic material, and/or a composite material. In some embodiments, the fluid reservoir 10 and/or the first chamber 13 may hold a volume of perfusion fluid 18 between 1000 milliliters (mL) and 5000 mL. Other sizes for the fluid reservoir 10, the first chamber 13, and/or volumes of perfusion fluid 18 are also contemplated.

In some embodiments, the fluid reservoir 10 may include an outlet port 16. In some embodiments, the outlet port 16 may include a shut off valve or a stopcock, as shown in FIG. 2 for example, to selectively permit or prevent fluid flow through the outlet port 16. In some embodiments, the system may include a perfusion fluid filter 20 operatively connected to the fluid reservoir 10 and/or the first chamber 13. In some embodiments, the perfusion fluid filter 20 may be integrally formed within and/or included in the fluid reservoir 10, as illustrated in FIG. 2. In some embodiments, the perfusion fluid filter 20 may be a standalone component (e.g., may be spaced apart from the fluid reservoir 10) and fluidly connected to the outlet port 16 by the fluid inflow line 42 and/or by one fluid inflow line segment. As illustrated in FIG. 1, the perfusion fluid filter 20 may be disposed upstream of the oxygenator 40 to prevent accumulation of debris or other material within the oxygenator 40. In at least some embodiments, the fluid reservoir 10 may be configured to facilitate priming of the fluid inflow line 42 and/or the plurality of fluid inflow line segments. In at least some embodiments, the fluid reservoir 10 may be configured to facilitate priming of the fluid outflow line 44 and/or the plurality of fluid outflow line segments.

FIG. 3 illustrates another example configuration of the fluid reservoir 10 associated with the system. In some embodiments, the fluid reservoir 10 may include a plurality of chambers. For example, the plurality of chambers may include a first chamber 13 and a second chamber 15. Additional chambers and/or another quantity of chambers are also contemplated. In at least some embodiments, each of the plurality of chambers may be fluidly isolated from each other. In some embodiments, the first chamber 13 of the fluid reservoir 10 may include the perfusion fluid 18 disposed therein and the second chamber 15 of the fluid reservoir 10 may be initially empty. In some embodiments, the fluid reservoir 10 may include a valve 11 configured to selectively direct perfusion fluid 18 returning to the fluid reservoir 10 into the first chamber 13 of the fluid reservoir 10 or the second chamber 15 of the fluid reservoir 10. Upon initial activation of the system, perfusion fluid 18 returning to the fluid reservoir 10 via the fluid outflow line 44 may be directed into the second chamber 15 via the valve 11. Actuation of the valve 11 at some time after initial activation of the system may direct perfusion fluid 18 returning to the fluid reservoir 10 via the fluid outflow line 44 into the first chamber 13 via the valve 11. In some embodiments, the fluid reservoir 10 may be configured to facilitate blood and/or perfusion fluid management during warming and/or cooling of the perfusion fluid 18 and/or the donated organ, as discussed in more detail herein. For example, the fluid reservoir 10 may be configured to facilitate management of a mixture and/or concentration of blood and/or perfusion fluid 18 being transported to and/or returning from the donated organ.

In some embodiments, the fluid reservoir 10 may be formed from a metallic material, a polymeric material, a ceramic material, and/or a composite material. In some embodiments, the first chamber 13 of the fluid reservoir 10 may be configured to hold a maximum of 1300 mL and the second chamber 15 of the fluid reservoir 10 may be configured to hold a maximum of 2700 mL. Other sizes and/or capacities for the first chamber 13 and/or the second chamber 15 are also contemplated.

In some embodiments, the fluid reservoir 10 may include a plurality of inlet ports fluidly connected to the plurality of chambers, the first chamber 13, and/or the second chamber 15 disposed within the fluid reservoir 10. In some embodiments, the plurality of inlet ports may include a first port 12 and a second port 14. In at least some embodiments, the first port 12 may be fluidly connected to the valve 11. In some embodiments, the second port 14 may include a plurality of second ports. In some embodiments, the plurality of inlet ports may be configured to receive drug infusions, additional perfusion fluid, or other suitable connections or uses. In at least some embodiments, each of the plurality of inlet ports may include a seal, a gasket, a diaphragm, or other covering configured to prevent contamination of the fluid reservoir 10, the plurality of chambers, the first chamber 13, the second chamber 15, and/or the perfusion fluid 18 disposed within the fluid reservoir 10, the plurality of chambers, the first chamber 13, and/or the second chamber 15.

In some embodiments, the fluid reservoir 10 may include a first outlet port 16 in fluid communication with first chamber 13 and a second outlet port 17 in fluid communication with second chamber 15. In some embodiments, the first outlet port 16 and/or the second outlet port 17 may each include a shut off valve or a stopcock, as shown in FIG. 3 for example, to selectively permit or prevent fluid flow through the first outlet port 16 and/or the second outlet port 17. In some embodiments, the system may include a perfusion fluid filter 20 operatively connected to the fluid reservoir 10 and/or the first chamber 13. In some embodiments, the perfusion fluid filter 20 may be integrally formed within and/or included in the fluid reservoir 10, as illustrated in FIG. 3. In some embodiments, the perfusion fluid filter 20 may be a standalone component (e.g., may be spaced apart from the fluid reservoir 10) and fluidly connected to the first outlet port 16 by the fluid inflow line 42 and/or by one fluid inflow line segment. As illustrated in FIG. 1, the perfusion fluid filter 20 may be disposed upstream of the oxygenator 40 to prevent accumulation of debris or other material within the oxygenator 40. In at least some embodiments, the fluid reservoir 10 may be configured to facilitate priming of the fluid inflow line 42 and/or the plurality of fluid inflow line segments. In at least some embodiments, the fluid reservoir 10 may be configured to facilitate priming of the fluid outflow line 44 and/or the plurality of fluid outflow line segments.

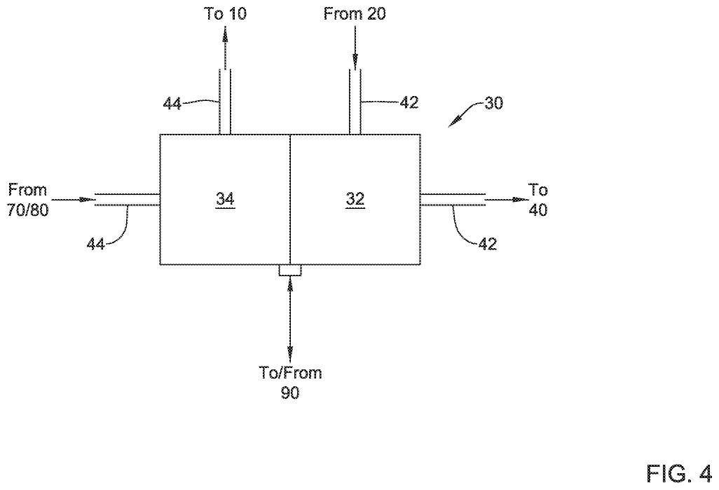

FIG. 4 illustrates an example configuration of the pump system 30 associated with the system. In some embodiments, the pump system 30 may be electronically connected (e.g., via a wired connection, via a wireless connection, etc.) to the controller 90. For ease of understanding, the pump system 30 is shown with a wired connection to the controller 90 in FIG. 4. In some embodiments, the pump system 30 may include an inflow pump 32 in fluid communication with the fluid reservoir 10 (and/or the perfusion fluid filter 20) and the oxygenator 40. In some embodiments, the fluid inflow line 42 and/or the plurality of fluid inflow line segments may fluidly connect the fluid reservoir 10, the perfusion fluid filter 20, the pump system 30 and the oxygenator 40. The inflow pump 32 may be configured to pressurize and/or cause flow of the perfusion fluid 18 from the fluid reservoir 10 to the donated organ 80.

In some embodiments, the inflow pump 32 may be a peristaltic pump. In some embodiments, the inflow pump 32 may include multiple pumps or more than one pump. The inflow pump 32 may be electrically driven and may receive power from a line source such as a wall outlet, an external or internal electrical storage device such as a disposable or rechargeable battery, and/or an internal power supply. The inflow pump 32 may operate at any desired speed sufficient to deliver fluid at a target pressure or a target flow rate. In some embodiments, the inflow pump 32 may be automatically adjusted based on, for example, pressure and/or flow readings within the pump system 30, the oxygenator 40, the fluid inflow line 42, and/or the donated organ 80. The inflow pump 32 may also be manually adjusted via, for example, an interface on the controller 90, an optional foot pedal, or other suitable means. It will be understood that any number of pumps may be used. In some embodiments, the pump system 30 may include multiple pumps having different flow capabilities. In some embodiments, a flow meter may be located before and/or after the inflow pump 32.

The fluid inflow line 42 and/or the plurality of fluid inflow line segments may be formed of a material that may be suitable to dampen the peristaltic motion created by the inflow pump 32. In some embodiments, the fluid inflow line 42 and/or the plurality of fluid inflow line segments may be formed from polymeric tubing having a diameter of about 1 mm to about 20 mm. It will be understood that tubing size may vary based on the application, the size of the donated organ 80, and/or other factors. In some embodiments, the fluid inflow line 42 and/or the plurality of fluid inflow line segments may be disposable and provided sterile and ready to use. In some embodiments, the fluid inflow line 42 and/or the plurality of fluid inflow line segments may be re-usable with suitable re-sterilization techniques applied between uses. In some embodiments, different types of tubing may be used for various functions within the system.

In some embodiments, the pump system 30 may include an outflow pump 34 in fluid communication with the fluid reservoir 10 and the donated organ 80 (and/or the organ holding basin 70). In some embodiments, the fluid outflow line 44 and/or the plurality of fluid outflow line segments may fluidly connect the fluid reservoir 10, the pump system 30 and the donated organ 80 (and/or the organ holding basin 70). The outflow pump 34 may be configured to pressurize and/or cause flow of the perfusion fluid 18 from the donated organ 80 (and/or the organ holding basin 70) to the fluid reservoir 10.

In some embodiments, the outflow pump 34 may be a peristaltic pump. In some embodiments, the outflow pump 34 may include multiple pumps or more than one pump. The outflow pump 34 may be electrically driven and may receive power from a line source such as a wall outlet, an external or internal electrical storage device such as a disposable or rechargeable battery, and/or an internal power supply. The outflow pump 34 may operate at any desired speed sufficient to deliver fluid at a target pressure or a target flow rate. In some embodiments, the outflow pump 34 may be automatically adjusted based on, for example, pressure and/or flow readings within the pump system 30, the fluid outflow line 44, and/or the donated organ 80. The outflow pump 34 may also be manually adjusted via, for example, an interface on the controller 90, an optional foot pedal, or other suitable means. It will be understood that any number of pumps may be used. In some embodiments, the pump system 30 may include multiple pumps having different flow capabilities. In some embodiments, a flow meter may be located before and/or after the outflow pump 34.

In some embodiments, the pump system 30, the inflow pump 32, and/or the outflow pump 34 may be configured to transport perfusion fluid 18 at flow rates of about 0.2 liters per minute (L/min) to about 4 L/min. Other configurations are also contemplated. In some embodiments, the pump system 30, the inflow pump 32, and/or the outflow pump 34 may be configured to transport perfusion fluid 18 at fluid pressures of about 0.2 mmHg to about 20 mmHg. Other configurations are also contemplated.

The fluid outflow line 44 and/or the plurality of fluid outflow line segments may be formed of a material that may be suitable dampen the peristaltic motion created by the inflow pump 32 and/or the outflow pump 34. In some embodiments, the fluid outflow line 44 and/or the plurality of fluid outflow line segments may be formed from polymeric tubing having a diameter of about 1 mm to about 20 mm. It will be understood that tubing size may vary based on the application, the size of the donated organ 80, and/or other factors. In some embodiments, the fluid outflow line 44 and/or the plurality of fluid outflow line segments may be disposable and provided sterile and ready to use. In some embodiments, the fluid outflow line 44 and/or the plurality of fluid outflow line segments may be re-usable with suitable re-sterilization techniques applied between uses. In some embodiments, different types of tubing may be used for various functions within the system.

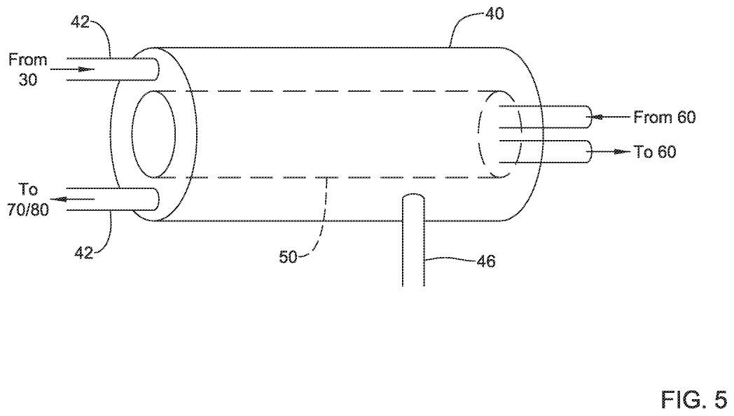

FIG. 5 illustrates an example configuration of the oxygenator 40 associated with the system. In some embodiments, the oxygenator 40 may be fluidly connected to the pump system 30 via the fluid inflow line 42 and/or one of the plurality of fluid inflow line segments. The oxygenator 40 may also be fluidly connected to the donated organ 80 (and/or the organ holding basin 70) via the fluid inflow line 42 and/or one of the plurality of fluid inflow line segments. In some embodiments, the oxygenator 40 may include an air supply line 46 connectable and/or configured to be connected to an air supply (not shown) for supplying oxygen to the oxygenator 40. In some embodiments, the oxygenator 40 may include an air supply port and/or an air supply inlet configured to be connected to the air supply. In some embodiments, the air supply may include one or more of a wall source, tanked air, canned air, portable air, an oxygen generator, or other suitable source of oxygen and/or air supply (of which oxygen is a component).

FIG. 5 also illustrates aspects of the heat exchanger 50 associated with the system. In the example configuration shown in FIG. 5, the heat exchanger 50 may be integrated with and/or within the oxygenator 40. As shown in FIG. 1, the heat exchanger 50 may be operatively and/or fluidly connected to the temperature changing unit 60 (e.g., the heater/cooler). In at least some embodiments, the temperature changing unit 60 (e.g., the heater/cooler) may be a part of and/or integrally formed with the heat exchanger 50. Accordingly, in some embodiments, the heat exchanger 50 and the temperature changing unit 60 (e.g., the heater/cooler) may comprise a single unit or structure. The controller 90 (e.g., FIG. 1) may be operatively connected to the heat exchanger 50 and/or the temperature changing unit 60 (e.g., the heater/cooler).

The heat exchanger 50 may include one or more internal fluid flow paths. The heat exchanger 50 may facilitate warming/heating and/or cooling of the perfusion fluid 18 passing though the oxygenator 40 via induction heating or other suitable means. The heat exchanger 50 may be configured to selectively warm/heat and/or cool the perfusion fluid 18 as the perfusion fluid 18 passes through the oxygenator 40. As such, a temperature of the perfusion fluid 18 may be raised and/or lowered as the perfusion fluid 18 is oxygenated on its way from the fluid reservoir 10 to the donated organ 80 (and/or the organ holding basin 70). In some embodiments, the temperature of the perfusion fluid 18 may be selectively raised and/or lowered within a range of about 2 degrees C. to about 40 degrees C., about 2 degrees C. to about 37 degrees C., about 4 degrees C. to about 37 degrees C., about 6 degrees C. to about 35 degrees C., or another suitable range and/or combination of these ranges (e.g., about 6 degrees C. to about 37 degrees C., etc.). The heat exchanger 50 may be capable of raising, lowering, and/or maintaining the temperature of the perfusion fluid 18 on demand within the range of about 2 degrees C. to about 40 degrees C., about 2 degrees C. to about 37 degrees C., about 4 degrees C. to about 37 degrees C., about 6 degrees C. to about 35 degrees C., or another suitable range and/or combination of these ranges (e.g., about 6 degrees C. to about 37 degrees C., etc.), based on input(s) from the controller 90. In describing temperatures, a temperature of less than 10 degrees C. is considered a hypothermic temperature, a temperature in the range of about 10 degrees C. to about 36 degrees C. is considered a sub-normothermic temperature, and a temperature of about 37 degrees C. is considered a normothermic temperature, or normal body temperature.

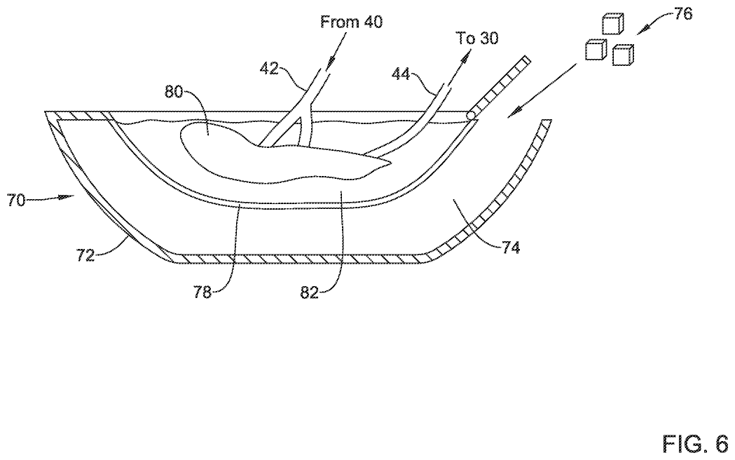

FIG. 6 illustrates an example configuration of the organ holding basin 70, shown in partial cross-section, associated with the system. The organ holding basin 70 may include an inner basin 78 and an outer shell 72. The organ holding basin 70 may have an organ bathing fluid 82 disposed within the inner basin 78 of the organ holding basin 70. In some embodiments, the organ bathing fluid 82 may include and/or may be donated blood (e.g., blood from a blood bank). In some embodiments, the organ bathing fluid 82 may include and/or may be blood from the donor of the donated organ 80. In some embodiments, the organ bathing fluid 82 may include and/or may be a preservation solution, a machine perfusion solution, or blood mixed with other components to achieve desired physical and/or functional properties at various temperatures. In some embodiments, the organ bathing fluid 82 may include a medicament or other therapy applicable to an outer surface of the donated organ 80. For example, the medicament may be configured to denature excess fat on the donated organ 80.

The organ holding basin 70 may be configured to receive the donated organ 80 in the organ bathing fluid 82 and/or the inner basin 78 after receiving the donated organ 80 from the donor. In some embodiments, a space 74 may be disposed between the outer shell 72 and the inner basin 78. In some embodiments, the organ holding basin 70 and/or the outer shell 72 is insulated. In some embodiments, the outer shell 72 may have a double-walled construction comprising an inner wall, an outer wall, and an insulating space disposed between the inner wall and the outer wall to provide insulative properties to the outer shell 72. The outer shell 72 may be configured to receive a temperature changing element 76 therein and/or within the space 74. In some embodiments, the temperature changing element 76 may be ice, water, ethylene or propylene glycol, or other suitable substances capable of providing the desired level of heating and/or cooling to the inner basin 78, the organ bathing fluid 82, and/or the donated organ 80 disposed therein.

In at least some embodiments, the organ holding basin 70 may include a point of entry providing access to the space 74. In some embodiments, the point of entry may include one or more of a door, a cover, a port, an inlet, or another suitable feature for accessing the space 74. In some embodiments, the point of entry may be hinged, sliding, snap-fit, etc. with respect to the organ holding basin 70 (e.g., the outer shell 72 and/or the inner basin 78) and/or may be removably attached to the organ holding basin 70, the outer shell 72, and/or the inner basin 78.

In some embodiments, a heat exchanger (e.g., the heat exchanger 50, a second heat exchanger, etc.) may be operatively connected to the organ holding basin 70 and/or the space 74 to selectively heat and/or cool the temperature changing element 76. In some embodiments, the organ holding basin 70 and/or the space 74 may be in fluid communication with the heat exchanger to selectively raise and/or lower a temperature of the organ bathing fluid 82. In one example, the inner basin 78 may facilitate heat transfer between the organ bathing fluid 82 and the temperature changing element 76. In another example, the inner basin 78 may be in fluid communication with the heat exchanger to selectively raise and/or lower the temperature of the organ bathing fluid 82. In this example, the organ bathing fluid 82 may flow to and from the heat exchanger to selectively raise and/or lower the temperature of the organ bathing fluid 82.

In some embodiments, the donated organ 80 may include more than one fluid input, such as when the donated organ 80 is a liver for example. In some embodiments, the fluid inflow line 42 may include a first fluid inflow line and a second fluid inflow line, as seen in FIG. 6 for example. Other configurations and/or quantities of fluid inflow lines are also contemplated. In some embodiments, the fluid inflow line 42 may split into the first fluid inflow line and the second fluid inflow line at a Y-connector upstream of and proximate to the donated organ 80. In some embodiments, the first fluid inflow line and the second fluid inflow line may be fluidly connected to and/or in fluid communication with the donated organ 80. In some embodiments, a quick-connect fitting (not shown) may be secured to and/or inserted into each fluid input into the donated organ 80. The first fluid inflow line may be connected to a first quick-connect fitting and the second fluid inflow line may be connected to a second quick-connect fitting. In some embodiments, a first cross-sectional area of the first fluid inflow line may be less than a cross-sectional area of the fluid inflow line 42 and a second cross-sectional area of the second fluid inflow line may be less than the cross-sectional area of the fluid inflow line 42. An inflow rate of perfusion fluid 18 through the first fluid inflow line and an inflow rate of perfusion fluid 18 through the second fluid inflow line may sum up to be equal to the inflow rate of perfusion fluid 18 through the fluid inflow line 42. For example, the inflow rate through the fluid inflow line 42 provided by the inflow pump 32 may be effectively split between the first fluid inflow line and the second fluid inflow line at the donated organ 80. In at least some embodiments, a quick-connect fitting (not shown) may be secured to and/or inserted into each fluid output from the donated organ 80. In the example of the donated organ 80 being a liver, the donated organ 80 may have a single fluid output connectable to and/or in fluid communication with the fluid outflow line 44. A cross-sectional area of the fluid outflow line 44 may be approximately equal to the cross-sectional area of the fluid inflow line 42. Accordingly, an outflow rate of perfusion fluid 18 flowing out of the donated organ 80 through the fluid outflow line 44 may be equal to the inflow rate of perfusion fluid 18 flowing into the donated organ 80. However, the cross-sectional area of the fluid outflow line 44 may not be equal to the cross-sectional area of the fluid inflow line 42 in all configurations. In some embodiments, the restrictions to fluid flow within the donated organ 80 may also affect fluid flow rate such that the inflow rate of perfusion fluid 18 and the outflow rate of perfusion fluid 18 are not necessarily equal. In at least some embodiments, the inflow pump 32 and the outflow pump 34 may be independently modulated and/or controlled by the controller 90 to maintain the inflow rate of perfusion fluid 18 flowing into the donated organ 80 equal to the outflow rate of perfusion fluid 18 flowing out of the donated organ 80.

In some embodiments, the organ holding basin 70 may optionally include a cover configured to protect the donated organ 80 and/or the organ bathing fluid 82 from contamination. In some embodiments, the cover may be spaced apart from the donated organ 80 and/or the organ bathing fluid 82 so as to avoid pressing against and/or applying pressure to the donated organ 80. In some embodiments, the cover may be configured to permit access to the donated organ 80 and/or the organ bathing fluid 82 for assessment, sampling, biopsy, imaging, and/or other treatments or procedures. Some suitable but non-limiting materials for the cover, including polymeric materials, metallic materials, composite materials, etc., are described below.

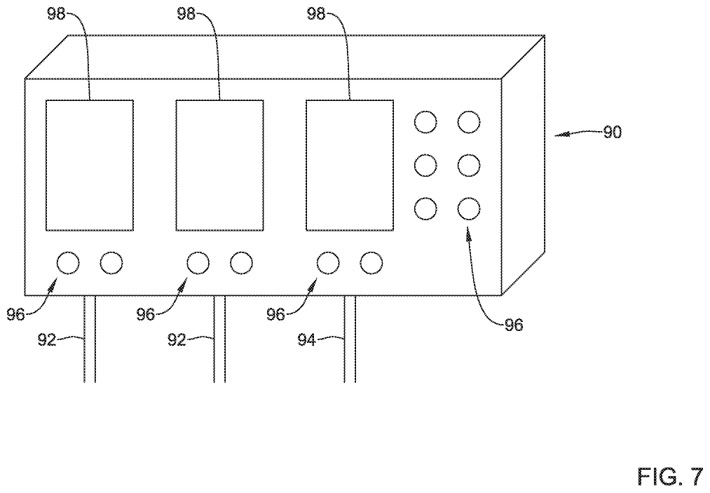

FIG. 7 illustrates an example configuration of the controller 90 associated with the system. In some embodiments, the controller 90 may be a standalone unit. In some embodiments, the controller 90 may be software running on a computer or processor. The controller 90 may be in electronic communication with one or more components of the system to provide control commands and/or to transfer or receive data therebetween. In some embodiments, the controller 90 may include one or more electronic cables 92 each configured to establish a wired connection to one or more components of the system (e.g., the heat exchanger 50 and/or the temperature changing unit 60 (e.g., the heater/cooler), the pump system 30, etc.). In some embodiments, the controller 90 may include wireless technology (e.g., radio frequency, Wi-Fi, Bluetooth, near field communication (NFC), etc.) configured to establish a wireless connection to one or more components of the system (e.g., the heat exchanger 50 and/or the temperature changing unit 60 (e.g., the heater/cooler), the pump system 30, etc.). In some embodiments, the controller 90 may include a power cable 94 configured to electrically connect the controller 90 to a power source (not shown). In some embodiments, the power source may be a wall outlet, a single-use battery, a re-chargeable battery, or some other suitable source of electrical power.

The controller 90 may include one or more user interface components. In some embodiments, the controller 90 may include a plurality of buttons 96, knobs, switches, and/or sensors configured to accept input(s) into the controller 90 and/or configured to adjust settings and/or parameters of the controller 90 or the system. In some embodiments, the plurality of buttons 96, knobs, switches, and/or sensors may be of a physical, touch-sensitive, resistive, or other suitable design or construction. In some embodiments, the controller 90 may include one or more display screens 98 configured to display parameters, settings, and/or data associated with operation of the system. In some embodiments, the one or more display screens 98 may include the plurality of buttons 96, knobs, switches, and/or sensors, for example, as an on-screen, selectable area providing functionality similar to a physical button. Other configurations are also contemplated.

In some embodiments, the controller 90 may use data received from various components of the system to independently control operational parameters of the pump system 30, the heat exchanger 50, and/or the temperature changing unit 60 (e.g., the heater/cooler). In some embodiments, the controller 90 may be configured to control the inflow pump 32 to maintain a target fluid flow rate based on a set of system operating parameters. In some embodiments, the controller 90 may be configured to control the outflow pump 34 to maintain a desired fluid flow rate based on a set of system operating parameters. In some embodiments, the controller 90 may be configured to independently control inflow pump speed and/or outflow pump speed to maintain an inflow rate of perfusion fluid 18 flowing into the donated organ 80 (and/or the organ holding basin 70) and an outflow rate of perfusion fluid 18 flowing out of the donated organ 80 (and/or the organ holding basin 70) that are equal. In some embodiments, the controller 90 may be configured to maintain the inflow rate of perfusion fluid 18 within about 10 percent of the outflow rate of perfusion fluid, within about 5 percent of the outflow rate of perfusion fluid, within about 2 percent of the outflow rate of perfusion fluid, or within about 1 percent of the outflow rate of perfusion fluid.

In some embodiments, the controller 90 may be configured to control flow of perfusion fluid 18 to the donated organ 80 (and/or the organ holding basin 70) based on the temperature of the perfusion fluid 18. The controller 90 may be configured to adjust the inflow pump speed and/or the inflow rate of perfusion fluid 18 based on the temperature of the perfusion fluid 18. In some instances, the inflow pump speed and/or the inflow rate of perfusion fluid 18 may be proportional to the temperature of the perfusion fluid 18. In some embodiments, the controller 90 may be configured to reduce the inflow pump speed and/or the inflow rate of perfusion fluid 18 when the temperature of the perfusion fluid 18 is below 4 degrees C. In some embodiments, the controller 90 may be configured to increase the inflow pump speed and/or the inflow rate of perfusion fluid 18 when the temperature of the perfusion fluid 18 is above 37 degrees C.

In some embodiments, the controller 90 may be configured to cyclically warm and cool the donated organ 80 over time. To accomplish this, the controller 90 may be configured to cyclically and selectively raise and/or lower the temperature of the perfusion fluid 18. For example, the controller 90 may be configured to raise the temperature of the perfusion fluid 18 and/or the donated organ 80 for a first period of time. After the first period of time has elapsed, the controller 90 may be configured to lower the temperature of the perfusion fluid 18 and/or the donated organ 80 for a second period of time. After the second period of time has elapsed, thus defining one cycle of raising and lowering the temperature of the perfusion fluid 18 and/or the donated organ 80, the controller may be configured to raise the temperature of the perfusion fluid 18 and/or the donated organ 80 for a third period of time. In some embodiments, this process may be repeated for a predetermined number of cycles. In some embodiments, this process may be repeated indefinitely, so long as the donated organ 80 remains viable and does not exhibit signs of significant injury or degraded function. In some instances, a cyclic warming/cooling mode may be selected with the controller 90 that will automatically cyclically warm (raise the temperature of the perfusion fluid 18 and/or the donated organ 80) and cool (lower the temperature of the perfusion fluid 18 and/or the donated organ 80) through multiple cycles over a period of time. It is believed that cyclically raising and lowering the temperature of the perfusion fluid 18 and/or the donated organ 80 over time, while maintaining oxygenation of the perfusion fluid 18 and/or the donated organ 80, may extend the preservation and viability of the donated organ 80 and reduce injury to the donated organ 80.

The controller 90 may allow a user to input/adjust various functions and/or parameters such as, for example perfusion fluid flow rate, perfusion fluid temperature, organ temperature, organ holding basin temperature, organ bathing fluid temperature, etc. The user may also configure parameters and alarms, information to be displayed, and/or a procedure mode. The controller 90 may allow the user to add, change, and/or discontinue the use of various modular systems within the system. In some embodiments, operating parameters may be adjusted by touching the corresponding portion of the controller 90 and/or the plurality of buttons 96, knobs, switches, and/or sensors. The controller 90 and/or the one or more display screens 98 may also display visual alerts and/or audio alarms if parameters (e.g., flow rate, temperature, etc.) are above or below predetermined thresholds and/or ranges. In some embodiments, the controller 90 is capable of and configured to perform various functions such as calculation, control, computation, display, etc. The controller 90 is also capable of tracking and storing data pertaining to the operations of the system and each component thereof.

In some embodiments, the controller 90 may be configured to monitor and/or display one or more different data points. The one or more different data points may include, but are not limited to, gas concentration, fluid pressure, fluid flow rate, the temperature of the perfusion fluid 18, the temperature of the donated organ 80, the temperature of the organ bathing fluid 82, pH level of the perfusion fluid 18, lactate levels, and/or other data of interest.

For example, in some embodiments, the controller 90 may be configured to monitor and/or display data related to real-time blood gas and biomarkers, including but not limited to pO2 (partial pressure of oxygen), pCO2 (partial pressure of carbon dioxide), pH, lactate, glucose, K+ (potassium), etc. In some embodiments, the controller 90 may be configured to monitor and/or display data related to real-time blood gas and biomarkers in the fluid inflow to the donated organ 80, the fluid outflow from the donated organ 80, or both. In some embodiments, the controller 90 may be configured to monitor and/or display data related to liver enzyme levels in the perfusion fluid 18, such as but not limited to LDH (lactate dehydrogenase), ASAT (aspartate aminotransferase), ALAT (alanine aminotransferase), etc. In some embodiments, the controller 90 may be configured to monitor and/or display data related to liver enzyme levels in the fluid inflow to the donated organ 80, the fluid outflow from the donated organ 80, or both. In some embodiments, the controller 90 may be configured to monitor and/or display data related to metabolite levels in the perfusion fluid 18, including but not limited to lactate, pyruvate, glucose, amino acids, triglycerides, etc. In some embodiments, the controller 90 may be configured to monitor and/or display data related to metabolite levels in the fluid inflow to the donated organ 80, the fluid outflow from the donated organ 80, or both. In some embodiments, the controller 90 may be configured to monitor and/or display data related to oxygen consumption in the perfusion fluid 18. In some embodiments, the controller 90 may be configured to monitor and/or display data related to oxygen consumption in the fluid inflow to the donated organ 80, the fluid outflow from the donated organ 80, or both. In some embodiments, the controller 90 may be configured to monitor and/or display data related to bile collection from the liver, including but not limited to bile output in milliliters per hour, bile pH, LDH, glucose, triglycerides, etc. Other clinical protocols, measurements, and/or biomarkers may also be monitored and/or displayed by the controller 90.

While not explicitly shown, in some embodiments, the heat exchanger 50 and/or the temperature changing unit 60 (e.g., the heater/cooler) may include a temperature user interface separate from the controller 90. The temperature user interface may simply be a display providing a readout of the internal temperature of the heat exchanger 50. In another embodiment, the temperature user interface may also include temperature adjustment buttons to increase or decrease the temperature of the heat exchanger 50, the temperature changing unit 60 (e.g., the heater/cooler), and/or the perfusion fluid 18 exiting the heat exchanger 50. In this embodiment, the temperature user interface and/or the display may indicate the current temperature of the heat exchanger 50, the temperature changing unit 60 (e.g., the heater/cooler), and/or the perfusion fluid 18 exiting the heat exchanger 50, as well as a target temperature to be reached. It is noted that all information output from the heat exchanger 50 and/or the temperature changing unit 60 (e.g., the heater/cooler) may be transmitted directly to the one or more display screens 98 such that no temperature user interface is necessary.

In some embodiments, the system and/or the controller 90 may be user selectable between a plurality of different operational modes based on the procedure, patient characteristics, etc. For example, different operational modes may include, but are not limited to, a de-fatting mode, a re-warming mode, a cyclic warming/cooling mode, a maintain viability mode, a therapy mode, etc. Once a mode has been selected by the user, default mode parameters such as perfusion fluid flow rate, inflow pump speed, outflow pump speed, perfusion fluid temperature, organ temperature, organ holding basin temperature, etc. may be provided to the user via the display screen and/or to the associated components of the system electronically. In some embodiments, exemplary parameters of the specific modes may be previously determined and loaded onto the controller 90 using, for example, software. In some embodiments, parameters of each mode may be manually set or changed by the user for, during, and/or according to each procedure.

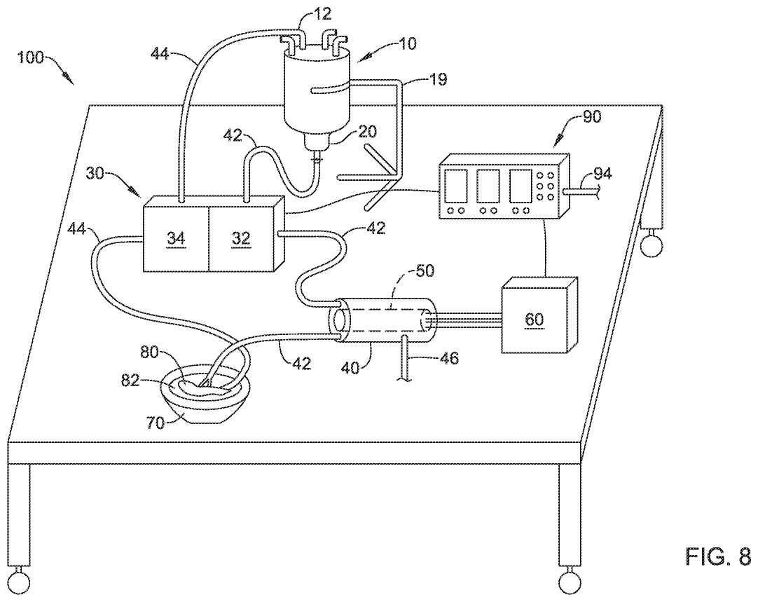

FIG. 8 illustrates an example configuration of the system of FIG. 1 including one or more of the components illustrated and/or described herein. Reference numbers used in FIG. 8 correspond to and/or reflect those used throughout the application and are not repeated herein. In at least some embodiments, the system may be placed on, mounted on, and/or may be secured to a mobile platform 100. In some embodiments, the mobile platform 100 may include a cart, a table, and/or a chassis. In some embodiments, the mobile platform 100 may include wheels, casters, slides, or other means of rendering the mobile platform 100 mobile or portable such that the system may be moved to and/or between different treatment rooms, operating rooms, etc. within the same treatment facility. In some embodiments, the system may have a form and/or features sufficient to render the system portable enough to accompany a patient and/or donor from one location to another location. In one example, it is contemplated that the system may be portable enough to accompany a donor from one hospital or treatment facility to another hospital or treatment facility where a patient may be located and/or waiting for treatment. For example, in some embodiments, some components of the system may be positioned relative to each other in a generally vertical configuration. In some embodiments, some components of the system may be positioned relative to each other in a generally horizontal configuration. Various combinations of horizontal and vertical relative positioning may also be used. Other configurations are also contemplated.

In some treatments, a donated organ 80 has been placed into cold storage and/or brought to a hypothermic state as a means to preserve the donated organ 80 prior to transplantation into a patient. A novel system and method of re-warming the donated organ 80 from the hypothermic state to a normothermic state (e.g., body temperature, about 37 degrees C., etc.) using selected features of the disclosure has been determined to reduce re-warming injury and/or to prolong preservation of the donated organ 80.

In some embodiments, a method of selectively re-warming the donated organ 80 for transplantation may include disposing the donated organ 80 in an organ holding basin 70 containing an organ bathing fluid 82 disposed therein. In some embodiments, the organ bathing fluid 82 may include and/or may be a preservation solution, a machine perfusion solution, and/or blood mixed with other components to achieve desired physical and/or functional properties at various temperatures. In some embodiments, at least some preservation solution may be disposed within the donated organ 80.

The method may further include connecting the fluid inflow line 42 and the fluid outflow line 44 of the system to the donated organ 80, after the donated organ 80 has been disposed in and/or bathed in the organ bathing fluid 82. The organ bathing fluid 82 may be kept in and/or may be previously chilled to a temperature conducive to maintaining the donated organ in the hypothermic state. After connecting the fluid inflow line 42 and the fluid outflow line 44 to the donated organ 80, the method may include activating the inflow pump 32 to transport perfusion fluid 18 from the first chamber 13 of the fluid reservoir 10 to the donated organ 80. The method may also include activating the outflow pump 34 to transport perfusion fluid 18 mixed with preservation solution away from the donated organ 80 and to the second chamber 15 of the fluid reservoir 10. Upon initial activation of the system, perfusion fluid 18 from the first chamber 13 of the fluid reservoir 10 may be fed into the donated organ 80 through the fluid inflow line 42, and perfusion fluid 18 (mixed with preservation solution) may be transported away from the donated organ 80 through the fluid outflow line 44 and into the second chamber 15 via the valve 11.

The method may further include, at some time after initial activation of the system, actuating the valve 11 to direct perfusion fluid 18 (and the preservation solution mixed therein) being transported away from the donated organ 80 into the first chamber 13 after the perfusion fluid 18 contains less than a threshold amount of preservation solution (e.g., less than 20 percent, less than 15 percent, or less than 10 percent preservation solution by volume) mixed therein. In some embodiments, the method may include actuating the valve 11 to direct perfusion fluid 18 (and the preservation solution mixed therein) being transported away from the donated organ 80 into the first chamber 13 after the perfusion fluid 18 contains less than 10 percent preservation solution mixed therein. In some embodiments, the method may include actuating the valve 11 to direct perfusion fluid 18 (and the preservation solution mixed therein) being transported away from the donated organ 80 into the first chamber 13 after the perfusion fluid 18 contains less than 5 percent preservation solution mixed therein. In some embodiments, the method may include actuating the valve 11 to direct perfusion fluid 18 (and the preservation solution mixed therein) being transported away from the donated organ 80 into the first chamber 13 after the perfusion fluid 18 contains less than 3 percent preservation solution mixed therein. In some embodiments, the method may include actuating the valve 11 to direct perfusion fluid 18 (and the preservation solution mixed therein) being transported away from the donated organ 80 into the first chamber 13 after the perfusion fluid 18 contains less than 1 percent preservation solution mixed therein. Other configurations are also contemplated. Thereafter, the method may include recirculating the perfusion fluid 18 (with a minimal amount of preservation solution potentially mixed therein) between the first chamber 13 and the donated organ 80. As such, after actuating the valve 11 to direct perfusion fluid 18 returning to the fluid reservoir 10 into the first chamber 13, the perfusion fluid 18 is thereafter recirculated between the first chamber 13 of the fluid reservoir 10 and the donated organ 80.

In some embodiments, the method may further include warming the perfusion fluid 18 with the heat exchanger 50 to raise a temperature of the donated organ 80 from an initial temperature in the hypothermic state to a first temperature. In some embodiments, the first temperature may be higher than the initial temperature of the donated organ 80. For example, the temperature of the donated organ 80 may be raised to a sub-normothermic state or a normothermic state. In some embodiments, the method may include, after warming the perfusion fluid 18 to raise the temperature of the donated organ 80 to the first temperature, cooling the perfusion fluid 18 with the heat exchanger 50 to lower the temperature of the donated organ 80 to a second temperature. In some embodiments, the second temperature may be less than the first temperature. In some embodiments, the second temperature may be the initial temperature. In some embodiments, the second temperature may be between the initial temperature and the first temperature. In some embodiments, the second temperature may place and/or maintain the donated organ 80 in the sub-normothermic state or the hypothermic state. In some embodiments, the method may include, after cooling the perfusion fluid 18 to lower the temperature of the donated organ 80 to the second temperature, re-warming the perfusion fluid 18 with the heat exchanger 50 to raise the temperature of the donated organ 80 to a third temperature. In some embodiments, the third temperature may be less than the first temperature. In some embodiments, the third temperature may be greater than the first temperature. In some embodiments, the third temperature may be equal to the first temperature. In some embodiments, the third temperature may place and/or maintain the donated organ 80 in the sub-normothermic state or the normothermic state.

In some embodiments, the method may include cyclically raising and lowering the temperature of the perfusion fluid 18 and/or the donated organ 80 within a range of 2 degrees C. to 40 degrees C., 2 degrees C. to 37 degrees C., 4 degrees C. to 37 degrees C., 6 degrees C. to 35 degrees C., or another suitable range and/or combination of these ranges, for example. In some embodiments, the method may include warming the perfusion fluid 18 with the heat exchanger 50 to raise a temperature of the donated organ 80 to 37 degrees C., applying a therapy to the donated organ 80, and cooling the perfusion fluid 18 with the heat exchanger 50 to lower the temperature of the donated organ 80 to 4 degrees C. In some embodiments, applying the therapy to the donated organ 80 may include introducing a medicament into the perfusion fluid 18. In some embodiments, applying the therapy to the donated organ 80 may include introducing a medicament into the organ bathing fluid 82. In one example, the medicament may be configured to de-nature fat on the donated organ 80. Other therapies are also contemplated.

In some treatments, a donated organ 80 may need to be preserved prior to transplantation into a patient, for example to accommodate transportation of the donated organ 80 and/or to permit the receiving patient time to arrive at the transplant center. A novel system and method of preserving the donated organ 80 using selected features of the disclosure has been determined to prolong preservation of the donated organ 80 and/or may permit the use of donated organs that might otherwise be unsuitable for transplantation.

In some embodiments, a method of preserving the donated organ 80 for transplantation may include disposing the donated organ 80 in an organ holding basin 70 containing an organ bathing fluid 82 disposed therein. In some embodiments, the organ bathing fluid 82 may include and/or may be a preservation solution, a machine perfusion solution, and/or blood mixed with other components to achieve desired physical and/or functional properties at various temperatures. In some embodiments, the organ bathing fluid 82 may be blood (e.g., from a blood bank, from the donor of the donated organ 80, etc.). In some embodiments, at least some of the organ bathing fluid 82 may be disposed within the donated organ 80.

The method may further include connecting the fluid inflow line 42 and the fluid outflow line 44 of the system to the donated organ 80. In some embodiments, the fluid inflow line 42 and/or the fluid outflow line 44 may be connected after the donated organ 80 has been disposed in and/or bathed in the organ bathing fluid 82. In some embodiments, the fluid inflow line 42 and/or the fluid outflow line 44 may be connected before the donated organ 80 has been disposed in and/or bathed in the organ bathing fluid 82. The organ bathing fluid 82 may be kept in and/or may be previously chilled to a temperature conducive to maintaining the donated organ 80 in the hypothermic state. In some embodiments, the organ bathing fluid 82 may be cooled to the temperature conducive to maintaining the donated organ 80 in the hypothermic state after the donated organ 80 has been disposed within the organ holding basin 70 and/or the organ bathing fluid 82.

After connecting the fluid inflow line 42 and the fluid outflow line 44 to the donated organ 80, the method may include activating the inflow pump 32 to transport perfusion fluid 18 from the fluid reservoir 10 to the donated organ 80. In at least some embodiments, activating the inflow pump 32 may transport perfusion fluid 18 from the first chamber 13 of the fluid reservoir 10 to the donated organ 80.

The method may also include activating the outflow pump 34 to transport perfusion fluid 18 from the donated organ 80 and back to the fluid reservoir 10. In some embodiments, activating the outflow pump 34 may transport perfusion fluid 18 from the donated organ 80 and back to the first chamber 13 of the fluid reservoir 10. In some embodiments, activating the outflow pump 34 may transport perfusion fluid 18 from the donated organ 80 and back to the second chamber 15 of the fluid reservoir 10. For example, in some embodiments, upon initial activation of the system, perfusion fluid 18 from the first chamber 13 of the fluid reservoir 10 may be fed into the donated organ 80 through the fluid inflow line 42, and perfusion fluid 18 may be transported away from the donated organ 80 through the fluid outflow line 44 and into the second chamber 15 via the valve 11. The method may further include, at some time after initial activation of the system, actuating the valve 11 to direct perfusion fluid 18 being transported away from the donated organ 80 into the first chamber 13 instead of the second chamber 15. As such, the method may include managing a concentration of the perfusion fluid 18 being fed into and/or transported away from the donated organ 80. Thereafter, the method may include recirculating the perfusion fluid 18 between the first chamber 13 of the fluid reservoir 10 and the donated organ 80. For example, in embodiments where the perfusion fluid 18 is blood, and the donated organ 80 includes and/or has a preservation solution disposed therein, the fluid reservoir 10 and/or the valve 11 may permit blood management up to 50 percent, up to 70 percent, up to 80 percent, up to 90 percent, or up to 100 percent blood by volume within the perfusion fluid 18 (e.g., blood) and preservation solution mixture during warming and/or cooling of the perfusion fluid 18 and/or the donated organ 80.

In some embodiments, the method may further include cooling the perfusion fluid 18 with the heat exchanger 50 to lower a temperature of the donated organ 80 from an initial temperature in a normothermic state to a first temperature. For example, the temperature of the donated organ 80 may be lowered to a sub-normothermic state or a hypothermic state. In some embodiments, the method may include, after cooling the perfusion fluid 18 to lower the temperature of the donated organ 80 to the first temperature, warming the perfusion fluid 18 with the heat exchanger 50 to raise the temperature of the donated organ 80 to a second temperature. In some embodiments, the second temperature may be less than the initial temperature. In some embodiments, the second temperature may be the initial temperature. In some embodiments, the second temperature may be between the initial temperature and the first temperature. In some embodiments, the second temperature may place and/or maintain the donated organ 80 in the sub-normothermic state or the normothermic state. In some embodiments, the method may include, after warming the perfusion fluid 18 to raise the temperature of the donated organ 80 to the second temperature, re-cooling the perfusion fluid 18 with the heat exchanger 50 to lower the temperature of the donated organ 80 to a third temperature. In some embodiments, the third temperature may be less than the first temperature. In some embodiments, the third temperature may be greater than the first temperature. In some embodiments, the third temperature may be equal to the first temperature. In some embodiments, the third temperature may place and/or maintain the donated organ 80 in the sub-normothermic state or the hypothermic state.

In some embodiments, the method may include cyclically raising and lowering the temperature of the perfusion fluid 18 and/or the donated organ 80 within a range of 2 degrees C. to 40 degrees C., 2 degrees C. to 37 degrees C., 4 degrees C. to 37 degrees C., 6 degrees C. to 35 degrees C., or another suitable range or combination of these ranges, for example. In some embodiments, the method may include controlling a rate of warming and/or a rate of cooling of the temperature of the perfusion fluid 18 and/or the donated organ 80. In some embodiments, the rate of warming and/or the rate of cooling may be about 0.25 degrees C. per minute (degrees C./min), about 0.5 degrees C./min, about 0.75 degrees C./min, about 0.9 degrees C./min, about 1.0 degrees C./min, about 1.10 degrees C./min, about 1.25 degrees C./min, about 1.50 degrees C./min, about 2.0 degrees C./min, about 2.5 degrees C./min, about 3.0 degrees C./min, about 5.0 degrees C./min, or another suitable rate. In some embodiments, the rate of warming and/or the rate of cooling may vary over time as the temperature of the perfusion fluid 18 and/or the donated organ 80 changes. For example, as the temperature of the perfusion fluid 18 and/or the donated organ 80 approaches a predetermined target temperature, the rate of warming and/or the rate of cooling may be reduced or increased as desired.

In some embodiments, the method may include warming the perfusion fluid 18 with the heat exchanger 50 to raise a temperature of the donated organ 80 to 37 degrees C., applying a therapy to the donated organ 80, and cooling the perfusion fluid 18 with the heat exchanger 50 to lower the temperature of the donated organ 80 to 4 degrees C. In some embodiments, applying the therapy to the donated organ 80 may include introducing a medicament into the perfusion fluid 18. In some embodiments, applying the therapy to the donated organ 80 may include introducing a medicament into the organ bathing fluid 82. In one example, the medicament may be configured to de-nature fat on the donated organ 80. Other therapies are also contemplated. In some embodiments, the rate of warming of the temperature of the perfusion fluid 18 and/or the donated organ 80 may be different from the rate of cooling of the temperature of the perfusion fluid 18 and/or the donated organ 80. For example, the method may include warming the perfusion fluid 18 with the heat exchanger to raise the temperature of the perfusion fluid 18 and/or donated organ 80 at a rate of warming of 1.50 degrees C./min, and cooling the perfusion fluid 18 with the heat exchanger to lower the temperature of the perfusion fluid 18 and/or donated organ 80 at a rate of cooling of 1.0 degrees C./min, or in another example, those values may be reversed. Other rates and/or differences are contemplated within the range of rates of warming and/or cooling discussed herein.

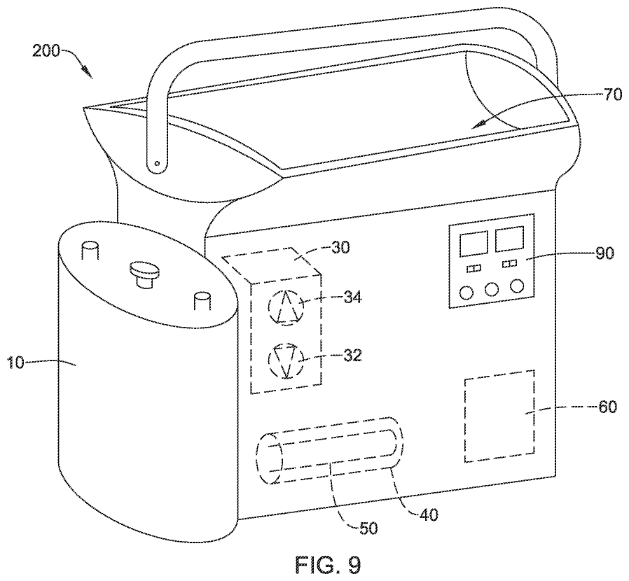

FIG. 9 illustrates an alternative configuration of the system of FIG. 1 including one or more of the components illustrated and/or described herein. Reference numbers used in FIG. 9 correspond to and/or reflect those used throughout the application and are not repeated herein. In at least some embodiments, the system may be incorporated into a portable carrier 200. In some embodiments, the portable carrier 200 may include a housing containing one or more of the components described above. In some embodiments, the portable carrier 200 may include a handle such that the system may be moved to and/or between various locations, such as from the organ donating location to the organ transplant location and/or different treatment rooms, operating rooms, etc. within the same treatment facility. In some embodiments, the system may have a form and/or features sufficient to render the system portable enough to accompany a patient and/or donor from one location to another location. In one example, it is contemplated that the system may be portable enough to accompany a donor from one hospital or treatment facility to another hospital or treatment facility where a patient may be located and/or waiting for treatment. For example, in some embodiments, some components of the system may be positioned relative to each other in a generally vertical configuration. In some embodiments, some components of the system may be positioned relative to each other in a generally horizontal configuration. Various combinations of horizontal and vertical relative positioning may also be used. Other configurations are also contemplated. As shown in FIG. 9, the portable carrier 200 may contain the pump system 30, including an inflow pump 32 and an outflow pump 34, an oxygenator 40, a heat exchanger 50 and associated temperature changing unit 60, as well as a controller 90. The portable carrier 200 may also include an organ holding basin 70 for holding an organ, as well as a fluid reservoir 10. The portable carrier 200 may also include fluid lines, fittings, valves, etc. connecting the various components, as described above.

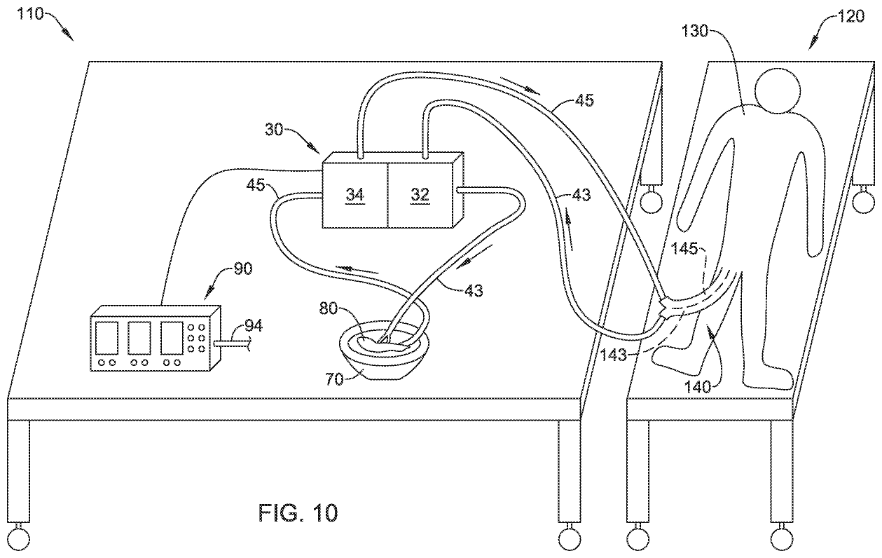

In some situations, a patient may experience an acute failure of an organ such as the liver. In such instances, the patient may benefit from a treatment that is less invasive and more quickly engaged than an organ transplant. One example of such a treatment is illustrated in the system of FIG. 10. In at least some embodiments, the system may be placed on, mounted on, and/or may be secured to a mobile platform 110. In some embodiments, the mobile platform 110 may include a cart, a table, and/or a chassis. In some embodiments, the mobile platform 110 may include wheels, casters, slides, or other means of rendering the mobile platform 110 mobile or portable such that the system may be moved to and/or between different treatment rooms, operating rooms, etc. within the same treatment facility. In some embodiments, the system may have a form and/or features sufficient to render the system portable enough to accompany a patient and/or donor from one location to another location. In one example, it is contemplated that the system may be portable enough to accompany a donor from one hospital or treatment facility to another hospital or treatment facility where a patient may be located and/or waiting for treatment. For example, in some embodiments, some components of the system may be positioned relative to each other in a generally vertical configuration. In some embodiments, some components of the system may be positioned relative to each other in a generally horizontal configuration. Various combinations of horizontal and vertical relative positioning may also be used. Other configurations are also contemplated.

The system may include a controller 90, such as the controller 90 described herein, in electronic communication with a pump system 30, such as that described herein. The controller 90 and the pump system 30 may be mounted to the mobile platform 110. Similarly, the system may include an organ holding basin 70, such as that described herein. A donated organ 80 may be disposed within the organ holding basin 70 and/or within an organ bathing fluid disposed in the organ holding basin 70, as in the above system(s). However, in this treatment, the donated organ 80 may be considered an extracorporeal organ configured to substitute for and/or replace the function of a failed organ within the patient 130, which patient may be disposed on an adjacent table 120 (e.g., hospital gurney, operating room table, etc.). Similar to the mobile platform 110, in some embodiments, the adjacent table 120 may be mobile and/or portable, and may include wheels, casters, slides, etc.

The system may include a dual-lumen cannula 140 configured to be fluidly connected to the donated organ 80 by a fluid inflow line 43 and a fluid outflow line 45, similar in form and function to the fluid inflow line 42 and the fluid outflow line 44, respectively, described above. For example, the fluid inflow line 43 may fluidly connect a first lumen 143 of the dual-lumen cannula 140 to an inflow pump 32 of the pump system 30 and the fluid inflow line 43 may also fluidly connect the inflow pump 32 to the fluid input(s) of the donated organ 80. Similarly, the fluid outflow line 45 may fluidly connect a second lumen 145 of the dual-lumen cannula 140 to an outflow pump 34 of the pump system 30 and the fluid outflow line 45 may also fluidly connect the outflow pump 34 to the fluid output(s) of the donated organ 80. The dual-lumen cannula 140 may be surgically and/or intravascularly inserted into the patient 130 to facilitate blood flow between the patient 130 and the donated organ 80. The pump system 30, the fluid inflow line 43, and the fluid outflow line 45 may also function to transport blood from the patient 130 to the donated organ 80. In doing so, the donated organ 80 may functionally replace the patient's native organ, which has suffered acute failure.

In some embodiments, the organ holding basin 70, the organ bathing fluid 82, and/or the donated organ 80 may be heated and/or cooled, as with the system described herein, while the donated organ 80 is connected to the patient 130. In some embodiments, a temperature of the organ holding basin 70, the organ bathing fluid 82, and/or the donated organ 80 may be cyclically raised and lowered while the donated organ 80 is connected to the patient 130. Other configurations and/or uses are also contemplated.

Those skilled in the art will recognize that embodiments of the present disclosure may be manifested in a variety of forms other than the specific embodiments described and contemplated herein. Accordingly, departure in form and detail may be made without departing from the scope and spirit of the present disclosure as described in the appended claims.

The materials that can be used for the various components of the system(s) and the various elements thereof disclosed herein may include those commonly associated with medical devices. For simplicity purposes, the following discussion refers to the system. However, this is not intended to limit the devices and methods described herein, as the discussion may be applied to other elements, members, components, or devices disclosed herein, such as, but not limited to, the system, the reservoir, the perfusion fluid filter, the inflow pump, the outflow pump, the oxygenator, the controller, the heat exchanger, the organ holding basin, and/or elements or components thereof.

In some embodiments, the system, and/or components thereof, may be made from a metal, metal alloy, polymer (some examples of which are disclosed below), a metal-polymer composite, ceramics, combinations thereof, and the like, or other suitable material.

Some examples of suitable polymers may include polytetrafluoroethylene (PTFE), ethylene tetrafluoroethylene (ETFE), fluorinated ethylene propylene (FEP), polyoxymethylene (POM, for example, DELRIN® available from DuPont), polyether block ester, polyurethane (for example, Polyurethane 85A), polypropylene (PP), polyvinylchloride (PVC), polyether-ester (for example, ARNITEL® available from DSM Engineering Plastics), ether or ester based copolymers (for example, butylene/poly(alkylene ether) phthalate and/or other polyester elastomers such as HYTREL® available from DuPont), polyamide (for example, DURETHAN® available from Bayer or CRISTAMID® available from Elf Atochem), elastomeric polyamides, block polyamide/ethers, polyether block amide (PEBA, for example available under the trade name PEBAX®), ethylene vinyl acetate copolymers (EVA), silicones, polyethylene (PE), MARLEX® high-density polyethylene, MARLEX® low-density polyethylene, linear low density polyethylene (for example REXELL®), polyester, polybutylene terephthalate (PBT), polyethylene terephthalate (PET), polytrimethylene terephthalate, polyethylene naphthalate (PEN), polyetheretherketone (PEEK), polyimide (PI), polyetherimide (PEI), polyphenylene sulfide (PPS), polyphenylene oxide (PPO), poly paraphenylene terephthalamide (for example, KEVLAR®), polysulfone, nylon, nylon-12 (such as GRILAMID® available from EMS American Grilon), perfluoro(propyl vinyl ether) (PFA), ethylene vinyl alcohol, polyolefin, polystyrene, epoxy, polyvinylidene chloride (PVdC), poly(styrene-b-isobutylene-b-styrene) (for example, SIBS and/or SIBS 50A), polycarbonates, polyurethane silicone copolymers (for example, ElastEon® from Aortech Biomaterials or ChronoSil® from AdvanSource Biomaterials), biocompatible polymers, other suitable materials, or mixtures, combinations, copolymers thereof, polymer/metal composites, and the like. In some embodiments the sheath can be blended with a liquid crystal polymer (LCP). For example, the mixture can contain up to about 6 percent LCP.

Some examples of suitable metals and metal alloys include stainless steel, such as 304V, 304L, and 316LV stainless steel; mild steel; nickel-titanium alloy such as linear-elastic and/or super-elastic nitinol; other nickel alloys such as nickel-chromium-molybdenum alloys (e.g., UNS: N06625 such as INCONEL® 625, UNS: N06022 such as HASTELLOY® C-22®, UNS: N10276 such as HASTELLOY® C276®, other HASTELLOY® alloys, and the like), nickel-copper alloys (e.g., UNS: N04400 such as MONEL® 400, NICKELVAC® 400, NICORROS® 400, and the like), nickel-cobalt-chromium-molybdenum alloys (e.g., UNS: R30035 such as MP35-N® and the like), nickel-molybdenum alloys (e.g., UNS: N10665 such as HASTELLOY® ALLOY B2®), other nickel-chromium alloys, other nickel-molybdenum alloys, other nickel-cobalt alloys, other nickel-iron alloys, other nickel-copper alloys, other nickel-tungsten or tungsten alloys, and the like; cobalt-chromium alloys; cobalt-chromium-molybdenum alloys (e.g., UNS: R30003 such as ELGILOY®, PHYNOX®, and the like); platinum enriched stainless steel; titanium; platinum; palladium; gold; combinations thereof; or any other suitable material.

In some embodiments, the system and/or other elements disclosed herein may include and/or be treated with a suitable therapeutic agent. Some examples of suitable therapeutic agents may include anti-thrombogenic agents (such as heparin, heparin derivatives, urokinase, and PPack (dextrophenylalanine proline arginine chloromethylketone)); anti-proliferative agents (such as enoxaparin, angiopeptin, monoclonal antibodies capable of blocking smooth muscle cell proliferation, hirudin, and acetylsalicylic acid); anti-inflammatory agents (such as dexamethasone, prednisolone, corticosterone, budesonide, estrogen, sulfasalazine, and mesalamine); antineoplastic/antiproliferative/anti-mitotic agents (such as paclitaxel, 5-fluorouracil, cisplatin, vinblastine, vincristine, epothilones, endostatin, angiostatin and thymidine kinase inhibitors); anesthetic agents (such as lidocaine, bupivacaine, and ropivacaine); anti-coagulants (such as D-Phe-Pro-Arg chloromethyl keton, an RGD peptide-containing compound, heparin, anti-thrombin compounds, platelet receptor antagonists, anti-thrombin antibodies, anti-platelet receptor antibodies, aspirin, prostaglandin inhibitors, platelet inhibitors, and tick antiplatelet peptides); vascular cell growth promoters (such as growth factor inhibitors, growth factor receptor antagonists, transcriptional activators, and translational promoters); vascular cell growth inhibitors (such as growth factor inhibitors, growth factor receptor antagonists, transcriptional repressors, translational repressors, replication inhibitors, inhibitory antibodies, antibodies directed against growth factors, bifunctional molecules consisting of a growth factor and a cytotoxin, bifunctional molecules consisting of an antibody and a cytotoxin); cholesterol-lowering agents; vasodilating agents; and agents which interfere with endogenous vasoactive mechanisms.

It should be understood that this disclosure is, in many respects, only illustrative. Changes may be made in details, particularly in matters of shape, size, and arrangement of steps without exceeding the scope of the present disclosure. This may include, to the extent that it is appropriate, the use of any of the features of one example embodiment being used in other embodiments. The scope of the present disclosure is, of course, defined in the language in which the appended claims are expressed.

What is claimed is:

1. An organ perfusion and preservation system for use in preserving an organ from a donor, comprising:
a fluid reservoir having a perfusion fluid disposed therein;
a heat exchanger in fluid communication with the fluid reservoir, the heat exchanger being configured to selectively raise and lower a temperature of the perfusion fluid;
an oxygenator configured to oxygenate the perfusion fluid;
an inflow pump in fluid communication with the fluid reservoir and the oxygenator;
a fluid inflow line configured to transport perfusion fluid from the oxygenator to the organ;
a fluid outflow line configured to transport perfusion fluid away from the organ and back to the reservoir;
an outflow pump in fluid communication with the fluid outflow line and the fluid reservoir; and
a controller operatively connected to the inflow pump, the outflow pump, and the heat exchanger;
wherein the controller is configured to select parameters to reversibly heat and reversibly cool the organ.

2. The system of claim 1, wherein the heat exchanger is integrated into the oxygenator.

3. The system of claim 1, wherein the controller is configured to independently control inflow pump speed and outflow pump speed to maintain an inflow rate of perfusion fluid flowing into the organ and an outflow rate of perfusion fluid flowing out of the organ that are equal.

4. The system of claim 3, wherein the controller is configured to control flow of perfusion fluid to the organ based on the temperature of the perfusion fluid.

5. The system of claim 1, wherein the controller is configured to cyclically warm and cool the organ over time.

6. The system of claim 1, wherein the perfusion fluid includes blood from the donor.

7. The system of claim 1, further including an organ holding basin having an organ bathing fluid disposed therein, wherein the organ holding basin is configured to receive the organ after receiving the organ from the donor.

8. The system of claim 7, wherein the organ bathing fluid includes a preservation solution.

9. The system of claim 7, wherein the organ bathing fluid includes blood from the donor.

10. The system of claim 1, wherein the fluid reservoir includes a plurality of chambers and a valve configured to selectively direct perfusion fluid returning to the fluid reservoir into a first chamber of the fluid reservoir or a second chamber of the fluid reservoir.

11. The system of claim 10, wherein upon initial activation of the system, perfusion fluid from the first chamber is fed into the organ through the fluid inflow line, and perfusion fluid is transported away from the organ through the fluid outflow line and into the second chamber via the valve.

12. The system of claim 11, wherein actuation of the valve at some time after initial activation directs perfusion fluid returning from the organ into the first chamber.

13. The system of claim 12, wherein after actuating the valve to direct perfusion fluid into the first chamber, perfusion fluid is thereafter recirculated between the first chamber and the organ.

14. A method of selectively re-warming a donated organ for transplantation, comprising:
disposing the donated organ in an organ holding basin containing a preservation solution disposed therein, wherein at least some preservation solution is disposed within the donated organ;
connecting a fluid inflow line and a fluid outflow line of an organ perfusion and preservation system to the donated organ, wherein the organ perfusion and preservation system comprises:
a fluid reservoir having a perfusion fluid disposed therein;
a heat exchanger in fluid communication with the fluid reservoir, the heat exchanger being configured to selectively raise and lower a temperature of the perfusion fluid;
an oxygenator configured to oxygenate the perfusion fluid;
an inflow pump in fluid communication with the fluid reservoir and the oxygenator;
wherein the fluid inflow line is configured to transport perfusion fluid from the oxygenator to the donated organ and the fluid outflow line is configured to transport perfusion fluid away from the donated organ and back to the reservoir;
an outflow pump in fluid communication with the fluid outflow line and the fluid reservoir; and
a controller operatively connected to the inflow pump, the outflow pump, and the heat exchanger;
wherein the controller is configured to select parameters to reversibly heat and reversibly cool the donated organ;
wherein the fluid reservoir includes a plurality of chambers and a valve configured to selectively direct perfusion fluid returning to the fluid reservoir into a first chamber of the fluid reservoir or a second chamber of the fluid reservoir;
activating the inflow pump to transport perfusion fluid from the first chamber of the fluid reservoir to the donated organ;
activating the outflow pump to transport perfusion fluid mixed with preservation solution away from the donated organ and to the second chamber;
actuating the valve to direct perfusion fluid being transported away from the donated organ into the first chamber after the perfusion fluid contains less than 20% preservation solution mixed therein; and
thereafter, recirculating the perfusion fluid between the first chamber and the donated organ.

15. The method of claim 14, further comprising:
warming the perfusion fluid with the heat exchanger to raise a temperature of the donated organ to a first temperature.

16. The method of claim 15, further comprising:
after warming the perfusion fluid, cooling the perfusion fluid with the heat exchanger to lower the temperature of the donated organ to a second temperature.

17. The method of claim 16, further comprising:
after cooling the perfusion fluid, re-warming the perfusion fluid with the heat exchanger to raise the temperature of the donated organ to a third temperature.

18. The method of claim 17, wherein the third temperature is equal to or greater than the first temperature.

19. The method of claim 17, further comprising:
cyclically raising and lowering the temperature of the donated organ within a range of 2 degrees C. to 40 degrees C.

20. The method of claim 14, further comprising:
warming the perfusion fluid with the heat exchanger to raise a temperature of the donated organ to 37 degree C.;
applying a therapy to the donated organ; and
cooling the perfusion fluid with the heat exchanger to lower the temperature of the donated organ to 4 degrees C.

21. A method of preserving a donated organ for transplantation, comprising:
disposing the donated organ in an organ holding basin containing an organ bathing fluid disposed therein;
connecting a fluid inflow line and a fluid outflow line of an organ perfusion and preservation system to the donated organ, wherein the organ perfusion and preservation system comprises:
a fluid reservoir having a perfusion fluid disposed therein;
a heat exchanger in fluid communication with the fluid reservoir, the heat exchanger being configured to selectively raise and lower a temperature of the perfusion fluid;
an oxygenator configured to oxygenate the perfusion fluid;
an inflow pump in fluid communication with the fluid reservoir and the oxygenator;
wherein the fluid inflow line is configured to transport perfusion fluid from the oxygenator to the donated organ and the fluid outflow line is configured to transport perfusion fluid away from the donated organ and back to the reservoir;
an outflow pump in fluid communication with the fluid outflow line and the fluid reservoir; and
a controller operatively connected to the inflow pump, the outflow pump, and the heat exchanger;
wherein the controller is configured to select parameters to reversibly heat and reversibly cool the donated organ;
activating the inflow pump to transport perfusion fluid from the fluid reservoir to the donated organ;
activating the outflow pump to transport perfusion fluid away from the donated organ and back to the fluid reservoir;
cooling the perfusion fluid with the heat exchanger to lower a temperature of the donated organ to a first temperature; and
recirculating the perfusion fluid between the fluid reservoir and the donated organ.

22. The method of claim 21, further comprising:
after cooling the perfusion fluid, warming the perfusion fluid with the heat exchanger to raise the temperature of the donated organ to a second temperature.

23. The method of claim 22, further comprising:
after warming the perfusion fluid, re-cooling the perfusion fluid with the heat exchanger to lower the temperature of the donated organ to a third temperature.

24. The method of claim 23, wherein the third temperature is equal to or less than the first temperature.

25. The method of claim 23, further comprising:
cyclically raising and lowering the temperature of the donated organ within a range of 2 degrees C. to 40 degrees C.

26. The method of claim 21, further comprising:
warming the perfusion fluid with the heat exchanger to raise the temperature of the donated organ to 37 degrees C.;
applying a therapy to the donated organ; and
cooling the perfusion fluid with the heat exchanger to lower the temperature of the donated organ to 4 degrees C.
